(19) United States
(12) Patent Application Publication
(10) Pub. No.: US 2012/0282413 A1
(43) Pub. Date: Nov. 8, 2012

(54) METHOD FOR SPRAYING MULTIPLE COMPONENTS

(75) Inventors: John Charles Larson, West Chester, PA (US); Robert John Barsotti, Franklinville, NJ (US); Laura Ann Lewin, Fort Colling, CO (US)

(73) Assignee: E.I.DU PONT DE NEMOURS AND COMPANY

(21) Appl. No.: 13/395,964

(22) PCT Filed: May 4, 2011
(86) PCT No.: PCT/US10/39959

§ 371 Date: Mar. 14, 2012

(51) Int. Cl. B05B 1/02; C08J 7/04; C08L 75/04; B05D 3/00

(52) U.S. Cl. 427/520; 427/426; 427/372.2; 524/871

(57) ABSTRACT

This invention is directed to a method for producing a coating layer of a coating composition by introducing a catalyst as a second component into an atomized stream of a first component of the coating composition. This invention is also directed to a spray gun for producing such coating layer.

### CROSS-REFERENCE TO RELATED APPLICATION

This application claims priority from U.S. Provisional Application Ser. No. 61/220333 (filed Jun. 25, 2009), the disclosure of which is incorporated by reference herein for all purposes as if fully set forth.

### FIELD OF INVENTION

The present invention is directed to a method for producing a coating layer with a coating composition. This invention is specifically directed to a method and a spray device for producing a coating layer by introducing a catalyst into an atomized stream of the coating composition.

### BACKGROUND OF INVENTION

Coatings on automotives or other objects typically comprise polymer networks formed by multiple reactive components of a coating composition. The coatings are typically applied onto a substrate such as automobile vehicle body or body parts using a spray device or other coating application techniques and then cured to form a coating layer having such polymer networks.

Currently, the multiple reactive components of the coating composition are typically mixed together to form a pot mix prior to spraying and placed in a cup-like reservoir or container that is attached to a spraying device such as a spray gun. Due to the reactive nature of the multiple reactive components, the pot mix will start to react as soon as they are mixed together causing continued increase in viscosity of the pot mix. Once the viscosity reaches a certain point, the pot mix becomes practically un-sprayable. The possibility that the spray gun itself may become clogged with crosslinked polymer materials is also disadvantageous. The time it takes for the viscosity to increase to such point where spraying becomes ineffective, generally a two-fold increase in viscosity, is referred to as “pot life”.

One way to extend “pot life” is to add a greater amount of thinning solvent, also known as thinning agent, to the pot mix. However, thinning agent, such as organic solvent, contributes to increased emissions of volatile organic compounds (VOC) and also increases curing time.

Other attempts to extend “pot life” of a pot mix of a coating composition have focused on “chemical-based” solutions. For example, it has been suggested to include modifications of one or more of the reactive components or certain additives that would retard polymerization reaction of the multiple components in the pot mix. The modifications or additives must be such that the rate of curing is not adversely affected after the coating is applied to the surface of a substrate.

Another approach is to mix one or more key components, such as a catalyst, together with other components of the coating composition immediately prior to spraying. One example is described in U.S. Pat. No. 7,201,289 in that a catalyst solution is stored in a separate dispenser and being dispensed and mixed with a liquid coating formulation before the coating formulation is atomized.

Yet another approach is to separately atomize two components, such as a catalyst and a resin, of a coating composition, and mix the two atomized components after spray. One such example is described in U.S. Pat. No. 4,824,017. However, such approach requires atomization of two components separately by using separate pumps and injection means for each of the two components.

### STATEMENT OF INVENTION

This invention is directed to a spray gun for producing a layer of a coating composition on a substrate, said spray gun comprising: a spray gun body (1), a first inlet (10), a spray nozzle (13) having a nozzle axis that is a rotational symmetry axis of said spray nozzle, an air cap (24), a second inlet (8), a second connection path (11), and a delivery outlet (14) having a delivery outlet axis substantially parallel to said nozzle axis;
wherein:
the first inlet is connected to said spray nozzle for conveying a first component of said coating composition to said spray nozzle;
the second inlet is connected to the delivery outlet through said delivery connection path for conveying a second component of said coating composition;
said spray nozzle is configured to produce a spray stream of atomized said first component creating a first siphon zone surrounding the spray nozzle; and
said delivery outlet is positioned within said siphon zone

This invention is also directed to a method for producing a layer of a coating composition on a substrate, said method comprising the steps of:

(A) providing a spray gun comprising: a spray gun body (1), a first inlet (10), a spray nozzle (13) having a nozzle axis that is a rotational symmetry axis of said spray nozzle, an air cap (24), a second inlet (8), a second connection path (11), and a delivery outlet (14) having a delivery outlet axis substantially parallel to said nozzle axis;

wherein:

the first inlet is connected to said spray nozzle for conveying a first component of said coating composition to said spray nozzle;

the second inlet is connected to the delivery outlet through said delivery connection path for conveying a second component of said coating composition;

said spray nozzle is configured to produce a spray stream of atomized said first component creating a first siphon zone surrounding the spray nozzle; and

said delivery outlet is positioned within said siphon zone;

(B) producing said spray stream of atomized said first component from said spray nozzle and siphoning said second component from said delivery outlet into said spray stream to form a coating mixture; and

(C) applying the coating mixture on the substrate to form the layer of said coating composition thereon.

### BRIEF DESCRIPTION OF DRAWING

FIG. 1 shows a schematic presentation of a spray gun.

FIG. 2 shows one embodiment of a nozzle-air cap assembly. (A) A frontal view of the nozzle-air cap assembly. (B) A detailed frontal view of the nozzle and delivery outlets.

FIG. 3 shows side cross sectional view of the nozzle-air cap assembly. (A), (B) and (C) Examples with second connection paths built in air cap. (D), (E) and (F) Examples with second connection paths affixed to the air cap surface. (G) Example with a second air channel.

FIG. 4 shows examples of configurations. (A) One single container is attached to two second inlets. (B) Two containers are connected to two second inlets.

FIG. 5 shows additional examples of configurations. (A) One single container is attached to two second inlets. (B) Two containers are connected to two second inlets.

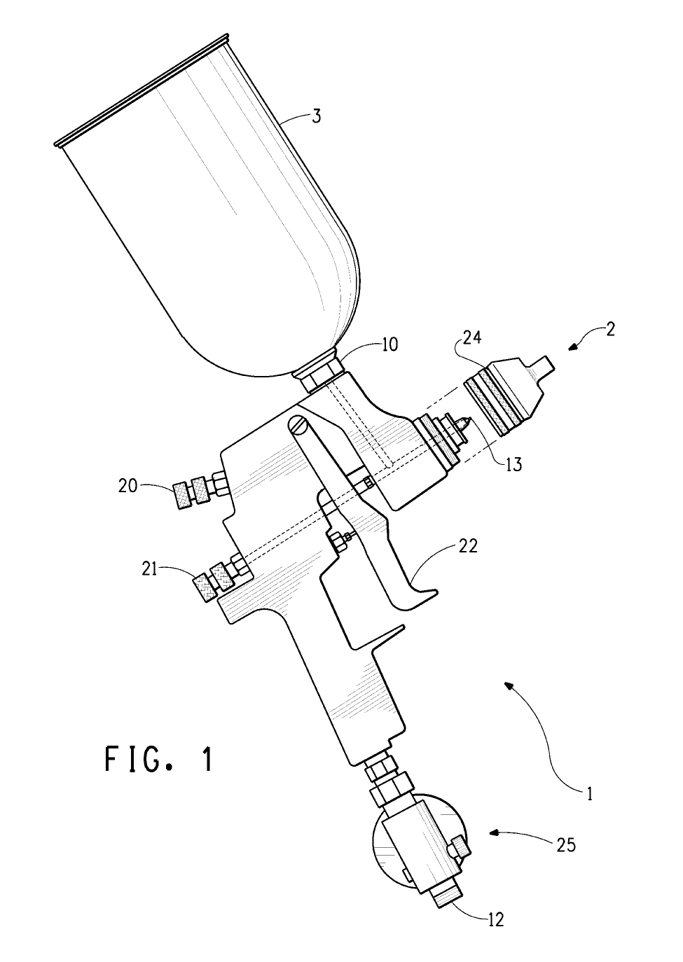

### DETAILED DESCRIPTION

The features and advantages of the present invention will be more readily understood, by those of ordinary skill in the art, from reading the following detailed description. It is to be appreciated that certain features of the invention, which are, for clarity, described above and below in the context of separate embodiments, may also be provided in combination in a single embodiment. Conversely, various features of the invention that are, for brevity, described in the context of a single embodiment, may also be provided separately or in any sub-combination. In addition, references in the singular may also include the plural (for example, “a” and “an” may refer to one, or one or more) unless the context specifically states otherwise.

The use of numerical values in the various ranges specified in this application, unless expressly indicated otherwise, are stated as approximations as though the minimum and maximum values within the stated ranges were both proceeded by the word “about.” In this manner, slight variations above and below the stated ranges can be used to achieve substantially the same results as values within the ranges. Also, the disclosure of these ranges is intended as a continuous range including every value between the minimum and maximum values.

As used herein:

“Two-pack coating composition”, also known as 2K coating composition, means a thermoset coating composition comprising two components that are stored in separate containers, which are typically sealed for increasing the shelf life of the components of the coating composition. The components are mixed just prior to use to form a pot mix, which has a limited pot life, typically from few minutes, such as 15 minutes to 45 minutes, to few hours, such as 4 hours to 10 hours. The pot mix is applied as a layer of desired thickness on a substrate surface, such as the body or body parts of a vehicle. After application, the layer dries and cures to form a coating on the substrate surface having desired coating properties, such as, desired gloss, mar-resistance, resistance to environmental etching and resistance to degradation by solvent. A typical two-pack coating composition can comprise a crosslinkable component and a crosslinking component.

“One-Pack coating composition”, also known as 1K coating composition, means a coating composition comprises multiple ingredients mixed in one single package. A one-pack coating composition can form a coating layer under certain conditions. One example of 1K coating composition can comprise a blocked crosslinking agent that can be activated under certain conditions. One example of the blocked crosslinking agent can be a blocked isocyanate. Another example of 1K coating composition can be a ultraviolet (UV) radiation curable coating composition.

The term “radiation”, “irradiation” or “actinic radiation” means radiation that causes, in the presence of a photo initiator, polymerization of monomers that have polymerizable ethylenically unsaturated double bonds, such as acrylic or methacrylic double bonds. Sources of actinic radiation may be natural sunlight or artificial radiation sources. Examples of actinic radiation include, but not limited to, UV radiation that has radiation wavelength in a range of from 100 nm to 800 nm, UV-A radiation, which falls within the wavelength range of from 320 nanometers (nm) to 400 nm; UV-B radiation, which is radiation having a wavelength falling in the range of from 280 nm to 320 nm; UV-C radiation, which is radiation having a wavelength falling in the range of from 100 nm to 280 nm; and UV-V radiation, which is radiation having a wavelength falling in the range of from 400 nm to 800 nm. Other examples of radiation can include electron-beam, also known as e-beam. A coating curable by radiation, such as UV, can be referred to as a radiation coating or a UV coating. A UV coating can be typically a 1K coating. A UV curable coating can typically have a UV curable component comprising monomers that have polymerizable ethylenically unsaturated double bonds, such as acrylic or methacrylic double bonds; and one or more photo initiators or radiation activators. Typically, a 1K coating composition, for example a UV mono-cure coating composition, can be prepared to form a pot mix and stored in a sealed container. As long as said UV mono-cure coating composition is not exposed to UV radiation, said UV mono-cure coating composition can have indefinite pot life.

A coating that can be cured by one curing mechanism, such as by chemical crosslinking alone or by UV radiation alone, can be referred to as a mono-cure coating. A coating that can be cured by both chemical and radiation, such as by both chemical crosslinking and UV radiation, is referred to as a dual-cure coating.

In one example, a dual-cure coating composition contains a first component having both radiation curable groups, such as acrylic double bonds, and chemical crosslinkable groups, such as hydroxyl groups, in one container. A second component contains a corresponding crosslinking agent having crosslinking groups, such as isocyanate groups and is stored in a second container. Just prior to use, the first component and the second component are mixed to form a pot mix. U.S. Pat. No. 6,815,501, for example, discloses a dual-cure type UV curable coating composition comprising a radiation curable component having polymerizable ethylenically unsaturated double bonds and a crosslinkable component having hydroxyl functional groups that can be cured by a combination of UV radiation and corsslinking component having isocyanate crosslinking agents. The crosslinkable component of a dual-cure coating composition can have other crosslinkabe functional groups described herein. The crosslinking component of a dual-cure coating composition can have other crosslinking functional groups described herein.

“Low VOC coating composition” means a coating composition that includes less than 0.6 kilograms per liter (5 pounds per gallon), preferably less than 0.53 kilograms (4.4 pounds per gallon) of volatile organic component, such as certain organic solvents. The phrase “volatile organic component” is herein referred to as VOC. VOC level is determined under the procedure provided in ASTM D3960.

“Crosslinkable component” includes a compound, oligomer, polymer or copolymer having functional crosslinkable groups positioned in each molecule of the compound, oligomer, the backbone of the polymer, pendant from the backbone of the polymer, terminally positioned on the backbone of the polymer, or a combination thereof. One of ordinary skill in the art would recognize that certain crosslinkable group combinations would be excluded from the crosslinkable component of the present invention, since, if present, these combinations would crosslink among themselves (self-crosslink), thereby destroying their ability to crosslink with the crosslinking groups in the crosslinking components defined below.

Typical crosslinkable component can have on an average 2 to 25, preferably 2 to 15, more preferably 2 to 5, even more preferably 2 to 3, crosslinkable groups selected from hydroxyl, acetoacetoxy, carboxyl, primary amine, secondary amine, epoxy, anhydride, imino, ketimine, aldimine, or a combination thereof.

The crosslinkable component can have protected crosslinkable groups. The “protected” crosslinkable groups are not immediately available for curing with crosslinking groups, but first must undergo a reaction to produce the crosslinkable groups. Examples of suitable protected crosslinkable components having protected crosslinkable groups can include, for example, amide acetal, orthocarbonate, orthoacetate, orthoformate, spiroorthoester, orthosilicate, oxazolidine or combinations thereof.

The protected crosslinkable groups generally are not crosslinkable without an additional chemical transformation. The chemical transformation for these groups can be a deprotection reaction such as hydrolysis reaction that unprotects the group to form a crosslinkable group that can then be reacted with the crosslinking component to produce a crosslinked network. Each one of these protected groups, upon the deprotection reaction, forms at least one crosslinkable group. For example, upon hydrolysis, an amide acetal can form an amide diol or one of two amino alcohols. As another example, the hydrolysis of an orthoacetate can form a hydroxyl group.

The crosslinkable component can contain compounds, oligomers and/or polymers that have crosslinkable functional groups that do not need to undergo a chemical reaction to produce the crosslinkable group. Such crosslinkable groups are known in the art and include, for example, hydroxyl, acetoacetoxy, thiol, carboxyl, primary amine, secondary amine, epoxy, anhydride, imino, ketimine, aldimine, silane, aspartate or a suitable combination thereof.

Suitable activators for deprotecting the protected crosslinkable component can include, for example, water, water and acid, organic acids or a combination thereof. In one embodiment, water or a combination of water and acid can be used as an activator to deprotect the crosslinkable component. For example, water or water with acid can be an activator for a coating described in PCT publication WO2005/092934, published on Oct. 6, 2005, wherein water activates hydroxyl groups by hydrolyzing orthoformate groups that block the hydroxyl groups from reacting with crosslinking functional groups.

“Crosslinking component” is a component that includes a compound, oligomer, polymer or copolymer having crosslinking functional groups positioned in each molecule of the compound, oligomer, the backbone of the polymer, pendant from the backbone of the polymer, terminally positioned on the backbone of the polymer, or a combination thereof, wherein these functional groups are capable of crosslinking with the crosslinkable functional groups on the crosslinkable component (during the curing step) to produce a coating in the form of crosslinked structures or networks. One of ordinary skill in the art would recognize that certain crosslinking group/crosslinkable group combinations would be excluded from the present invention, since they would fail to crosslink and produce the film forming crosslinked structures or networks.

Typical crosslinking component can be selected from a compound, oligomer, polymer or copolymer having crosslinking functional groups selected from the group consisting of isocyanate, amine, ketimine, melamine, epoxy, polyacid, anhydride, and a combination thereof. It would be clear to one of ordinary skill in the art that generally certain crosslinking groups from crosslinking components crosslink with certain crosslinkable groups from the crosslinkable components. Some of those paired combinations can include: (1) ketimine crosslinking groups generally crosslink with acetoacetoxy, epoxy, or anhydride crosslinkable groups; (2) isocyanate and melamine crosslinking groups generally crosslink with hydroxyl, primary and secondary amine, ketimine, or aldimine crosslinkable groups; (3) epoxy crosslinking groups generally crosslink with carboxyl, primary and secondary amine, ketimine, or anhydride crosslinkable groups; (4) amine crosslinking groups generally crosslink with acetoacetoxy crosslinkable groups; (5) polyacid crosslinking groups generally crosslink with epoxy crosslinkable groups; and (6) anhydride crosslinking groups generally crosslink with epoxy and ketimine crosslinkable groups.

A coating composition can further comprise a catalyst, an initiator, an activator, a curing agent, or a combination thereof. A coating composition can also comprise a radiation activator if the coating composition is a radiation curable coating composition, such as a UV curable coating composition.

A catalyst can initiate or promote the reaction between reactants, such as crosslinkable functional groups of a crosslinkable component and crosslinking functional groups of a crosslinking component of a coating composition. The amount of the catalyst depends upon the reactivity of functional groups. Generally, in the range of from about 0.001 percent to about 5 percent, preferably in the range of from 0.01 percent to 2 percent, more preferably in the range of from 0.02 percent to 1 percent, all in weight percent based on the total weight of the crosslinkable component solids, of the catalyst can be utilized. A wide variety of catalysts can be used, such as, tin compounds, including organotin compounds such as dibutyl tin dilaurate; or tertiary amines, such as, triethylenediamine. These catalysts can be used alone or in conjunction with carboxylic acids, such as, acetic acid. One example of commercially available catalysts is dibutyl tin dilaurate as Fascat® series sold by Arkema, Bristol, Pa., under respective trademark.

An activator can activate one or more components of a coating composition. For example, water can be an activator for a coating described in PCT publication WO2005/092934, published on Oct. 6, 2005, wherein water activates hydroxyl groups by hydrolyzing orthoformate groups that block the hydroxyl groups from reacting with crosslinking functional groups.

An initiator can initiate one or more reactions. Examples can include photo initiators and/or sensitizers that cause photopolymerization or curing of a radiation curable coating composition, such as a UV curable coating composition upon radiation, such as UV irradiation. Many photo initiators are known to those skilled in the art and can be suitable for this invention. Examples of photo initiators can include, but not limited to, benzophenone, benzion, benzionmethyl ether, benzion-n-butyl ether, benzion-iso-butyl ether, propiophenone, acetophenone, methyphenylgloxylate, 1-hydroxycyclohexyl phenyl ketone, 2, 2-diethoxyacetophenone, ethylphenylpyloxylate, diphenyl (2,4,6-trimethylbenzoyl)-phosphine oxide, phosphine oxide, phenyl bis (2,4,6-trimethyl benzoyl), phenanthraquinone, and a combination thereof. Other commercial photo initiator products, or a combination thereof, such as Darocure® 1173, Darocure® MBF, Darocure® TPO or Irgacure® 184, Irgacure® 4265, Irgacure® 819, Irgacure® 2022 or Irgacure® 2100 from Ciba Co., can also be suitable. Darocure® and Irgacure® are registered trademarks of Ciba Specialty Chemicals Corporation, New York.

A radiation activator can be activated by radiation and then initiate or catalyze subsequent one or more reactions. One example can be photolatent catalyst available from Ciba Specialty Chemicals.

A curing agent can react with other components of a coating composition to cure the coating composition into a coating. For example, a crosslinking component, such as isocyanate, can be a curing agent for a coating comprising a crosslinkable hydroxyl component. On the other hand, a crosslinkable component can be a curing agent for a crosslinking component.

In conventional coating practice, components of a two-pack coating composition are mixed immediately prior to spraying to form a pot mix which has a limited pot life, wherein said components can include a crosslinking component, a crosslinkable component, necessary catalysts, and other components necessary as determined by those skilled in the art. In addition to the limited pot life, many catalysts can change its activity in the pot mix. For example, some catalysts can be sensitive to the trace amount of water in the pot mix since water can cause hydrolysis and hence inactivation of the catalyst.

To extend pot life, one prior approach is to mix the catalyst with other components of the coating composition immediately prior to spraying. One example is described in aforementioned U.S. Pat. No. 7,201,289 in that a catalyst solution is stored in a separate dispenser and being dispensed and mixed with a liquid coating formulation before the coating formulation is atomized. However, this approach requires mixing the catalyst and the liquid coating composition prior to atomization.

Another example of prior approach is described in U.S. Pat. No. 4,824,017 in that a catalyst and a resin of a coating composition are separately atomized and mixed after atomization. However, such approach requires atomization of two components separately by using separate pumps and individual injection means for each of the two components. This approach also requires intensive adjustment and monitoring of the individual atomization and injection to ensure constant mixing ratio of the two components.

This invention is directed to a spray gun for producing a layer of a coating composition on a substrate.

The spray gun of this invention can comprise: a spray gun body (1), a first inlet (10), a spray nozzle (13) having a nozzle axis longitudinal to said spray nozzle, an air cap (24), a second inlet (8), a second connection path (11), and a delivery outlet (14) having a delivery outlet axis substantially parallel to said nozzle axis; wherein:
the first inlet is connected to said spray nozzle for conveying a first component of said coating composition to said spray nozzle;
the second inlet is connected to the delivery outlet through said delivery connection path for conveying a second component of said coating composition;
said spray nozzle is configured to produce a spray stream of atomized said first component creating a first siphon zone surrounding the spray nozzle; and
said delivery outlet is positioned within said siphon zone.

The spray gun body (1) can have additional multiple parts, controls, such as carrier coupling (12) for coupling to a source of a carrier, such as compressed air, a carrier regulator assembly (25) for regulating and measuring flow rate and pressure of the carrier, a coating flow regulator (21) for regulating flow of the first coating component that is stored in a main reservoir (3), and other mechanisms necessary for proper operation of a spray gun known to those skilled in the art. Additional control or parts can include, such as a trigger (22) and a spray fan regulator (20) for regulating compressed carrier such as compressed air jetting out from a set of shaping air jets (24a) for forming desired spray shape, such as a fan-shape. Typically, multiple channels, connectors, connection paths and mechanical controls can be assembled within the spray gun body. The spray gun body can also provide further assembly or operation mechanisms for additional parts or controls.

The first inlet (10) can be constructed or configured onto the spray gun body through means known to those skilled in the art. The first inlet is connected to the spray nozzle for conveying a first component of the coating composition to said spray nozzle. For a gravity fed spray gun, the main reservoir (3) is not pressurized and the first inlet can be typically positioned at the upper side of the spray gun body so the first component can be fed into the spray gun by gravity during normal spray operation, such as hand-held spraying.

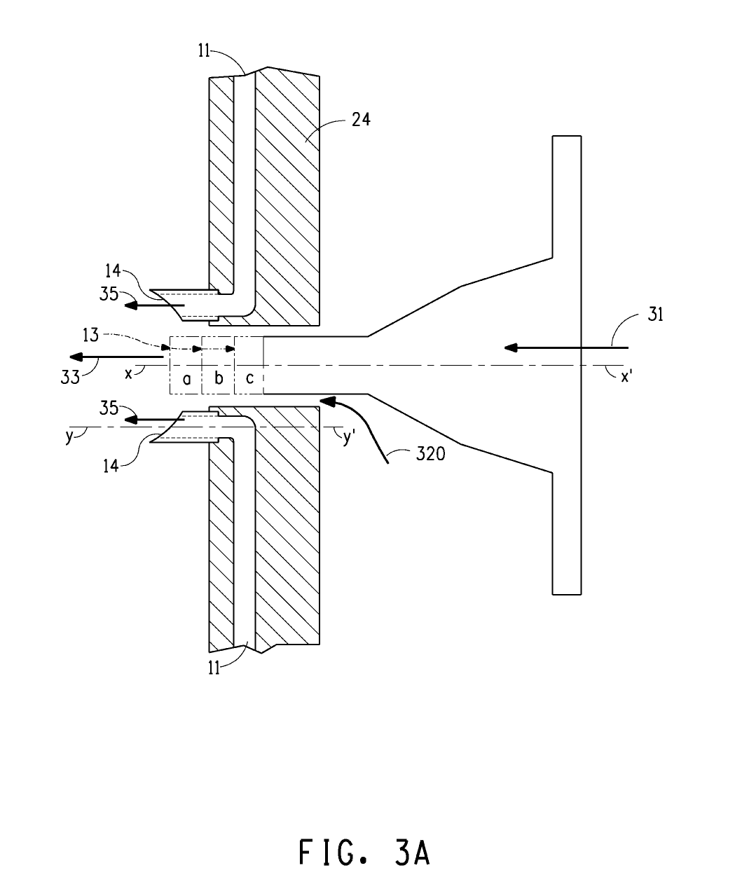

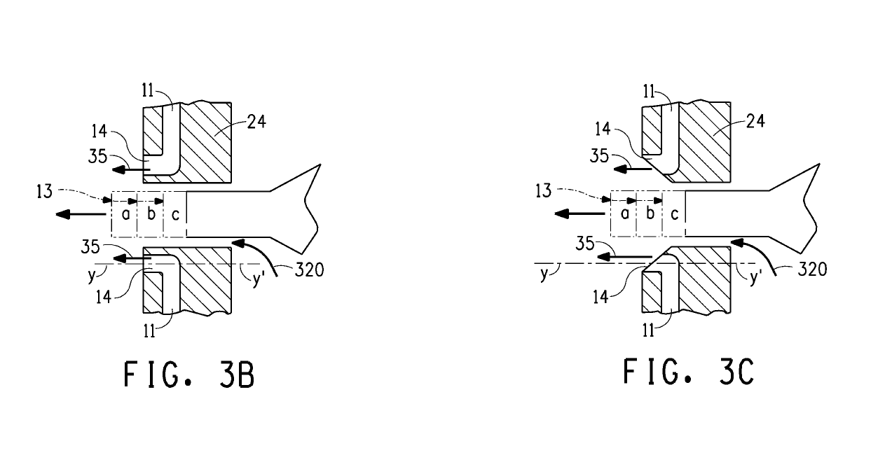

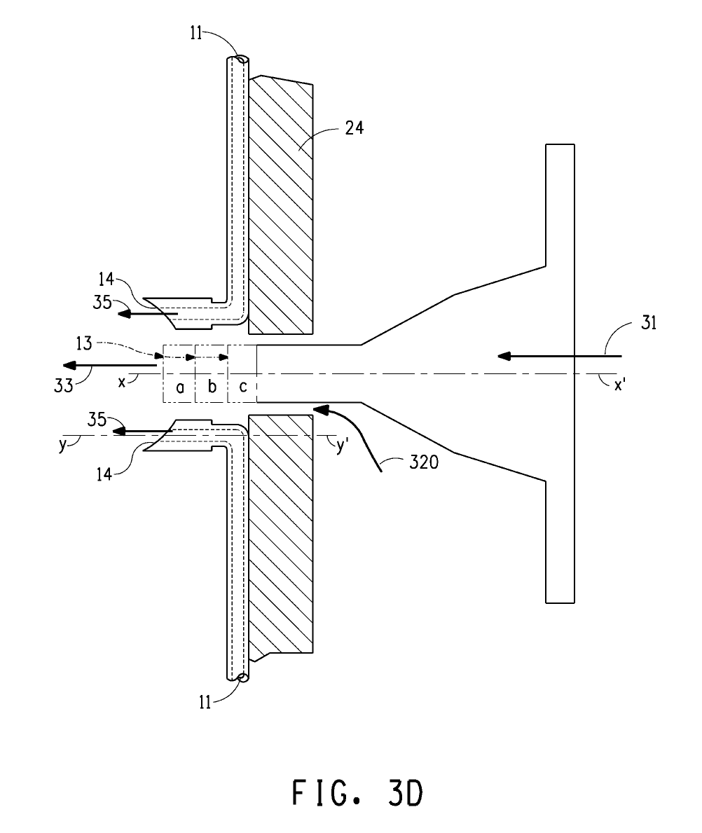

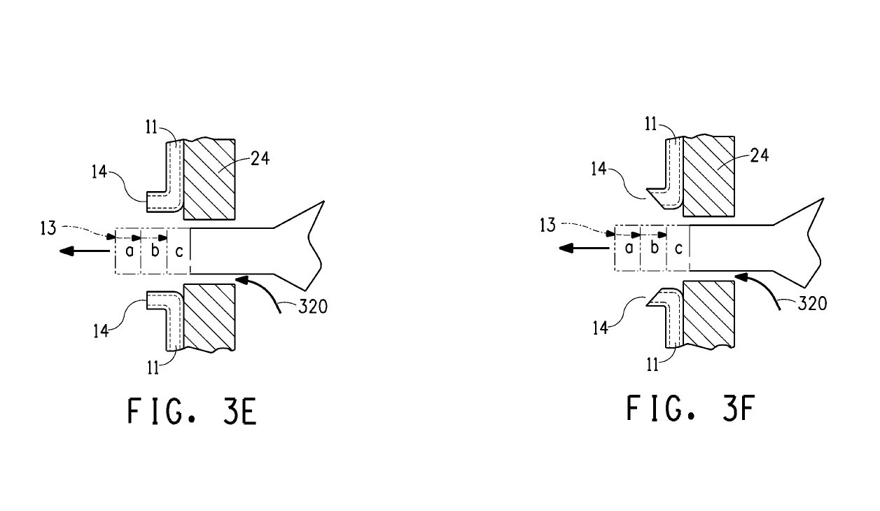

The spray nozzle (13) is typically a structure having an opening for spraying and can have a nozzle axis that is a rotational symmetry axis of said spray nozzle. In one example, the nozzle axis can be the axis shown as x-x′ (FIG. 3A). The spray nozzle can be typically configured to produce a spray stream of atomized first component. Such fast moving spray stream can create a first siphon zone surrounding the spray nozzle. The nozzle (13) and the air cap (24) form a nozzle-air cap assembly (2) when they are assembled together.

The first siphon zone can typically be a 3 dimensional space surrounding the spray nozzle that is in a range of from 0.01 mm to 20 mm away from the spray nozzle. The shapes and configurations of the air cap and the spray nozzle can affect the size and shape of the siphon zone. Velocity of carrier that is typically used for producing the spray stream can also affect the size and shape of the siphon zone. Particles or liquids can be siphoned into the first siphon zone and be forced to move together with or in a direction of the flow of the spray stream.

While not wishing to be bound by any particular theory, “siphoning” is believed to occur when the spray stream is moving at high speed at the spray nozzle causing negative air pressure around the spray nozzle. Such negative air pressure is believed to cause the second component to be conveyed to the delivery outlet. The second component can become atomized and be mixed into the spray stream. In this invention, the first and the second components can be mixed at a pre-determined mixing ratio to form the coating mixture. The second component can also be conveyed to the delivery outlet by gravity or a combination of gravity and siphoning in certain embodiments of configurations disclosed herein.

The second inlet (8) can be connected to the delivery outlet (14) through said delivery connection path (11) for conveying a second component of the coating composition. The second inlet can further be connected to a reservoir or a container that contains the second component so the second component can be supplied to the delivery outlet. The spray gun can typically have more than one second inlet, more than one second connection path, or more than one delivery outlet. The delivery outlet is positioned within the first siphon zone so the second or a subsequent component of the coating composition can be siphoned into the spray stream to form a coating mixture.

The delivery outlet (14) can typically have a delivery outlet axis substantially parallel to the nozzle axis. The delivery outlet axis is defined by the geo-center point of the opening of the delivery outlet and the siding of the delivery outlet that forms the opening of the delivery outlet. The delivery outlet axis is a theoretical straight line going through the geo-center point and parallel to the siding. One exemplary illustration of the delivery outlet axis is shown in FIG. 3 as the theoretical line y-y′.

The delivery outlet can be constructed as add-on and affixed to the nozzle or the air cap. The delivery outlet can also be constructed in the air cap. In on example, the delivery outlet is constructed as a small tube add-on and affixed to the air cap. In another example the delivery outlet can be constructed in the air cap.

In one example, the spray gun can have two delivery outlets (14). Each of the two delivery outlets (14) can be connected to a second connection path (11) and a second inlet (8). In another example, the spray gun can have three delivery outlets (14). Each of the three delivery outlets (14) can be connected to a second connection path (11) and a second inlet (8).

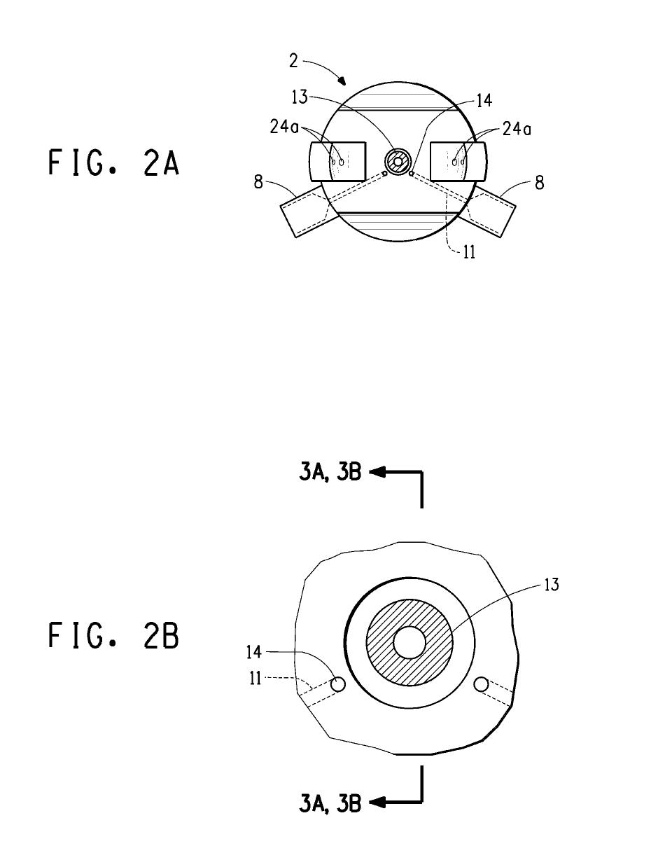

FIG. 2 shows a frontal view of an example of a nozzle-air cap assembly (2). In this example, two delivery outlets (14) are constructed in the air cap. Each of the delivery outlets is connected to an individual second connection path (11) and then to an individual second inlet (8). The delivery outlets can be arranged around the spray nozzle (13) in such positions that the delivery outlets are positioned with the siphon zone. Typically, the delivery outlets are positioned in a range of from 0.01 mm to 20 mm away from the spray nozzle. The delivery outlet (14) can be constructed by drilling into the air cap on the front of the air cap in a direction parallel to the nozzle axis. The depth of drilling can be in a range of from 1/10 to 9/10 of the thickness of the air cap. The second connection path (11) can be constructed by drilling from side of the air cap towards and intersecting with the delivery outlet. The second inlet (8) can be constructed by inserting a tubing into the second connection path (11), affixing a inlet coupling to the second connection path by screwing or welding, or any other ways determined appropriate by those skilled in the art.

The second connection path (11) can be in a straight line for easy construction and cleaning and can be arranged to start from any position on the side of the air cap as long as it intersects with the delivery outlet.

When multiple delivery outlets and second connection paths are present, those multiple delivery outlets and second connection paths can be arranged in a symmetric or asymmetric pattern. Symmetric arrangement patterns are shown in the Figures.

FIG. 3 shows side cross-section views of examples of details and configurations of the delivery outlets. The delivery outlet can be constructed to protrude from the surface of the air cap (FIG. 3A) or flush with the surface of the air cap (FIGS. 3B and 3C). The air cap can also be tapered at various angles towards a center opening of the air cap where pressurized carrier, such as pressurized air, flows through in the direction (320). The spray nozzle (13) can be positioned at various relative positions to the air cap, such as the positions a, b or c (FIGS. 3A, 3B, and 3C). The relative positions can be utilized to control or modify the siphon zone. The relative positions can also be utilized for modulating droplet size and mixing of the coating mixture. The nozzle axis shown as x-x′ is parallel to each of the delivery outlet axis shown as y-y′. The first component can flow into the nozzle in the direction shown by the arrow (31). The spray stream can jet out of the spray nozzle in the direction shown by the arrow (33). The second component can be siphoned out of the delivery outlet in the direction shown by arrow (35).

In another example, the delivery outlets, the second connection paths and the second inlets can be constructed as an add-on and affixed to the air cap. In such example, small tubes either made of metal or plastic, can be configured as shown in FIGS. 3D, 3E, and 3F and affixed on the surface of the air cap.

The spray gun can further comprise a second air channel (38) for producing a second siphon zone. The second air channel (38) can be configured within the delivery outlet (14) or in close proximity to the delivery outlet. In one example, the second air channel is configured within each of the delivery outlets (FIG. 3G). Compressed air (320) can pass the gap between the air cap and the nozzle and the second air channel at high velocity. The second siphon zone and the first siphon zone can be the same or different. The first and the second siphon zone can also be combined together to form an extended siphon zone.

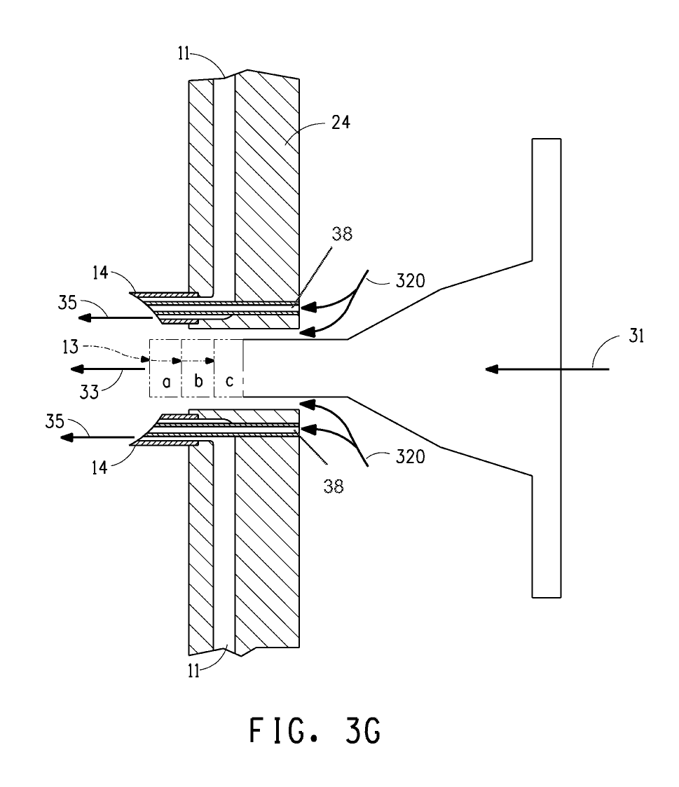

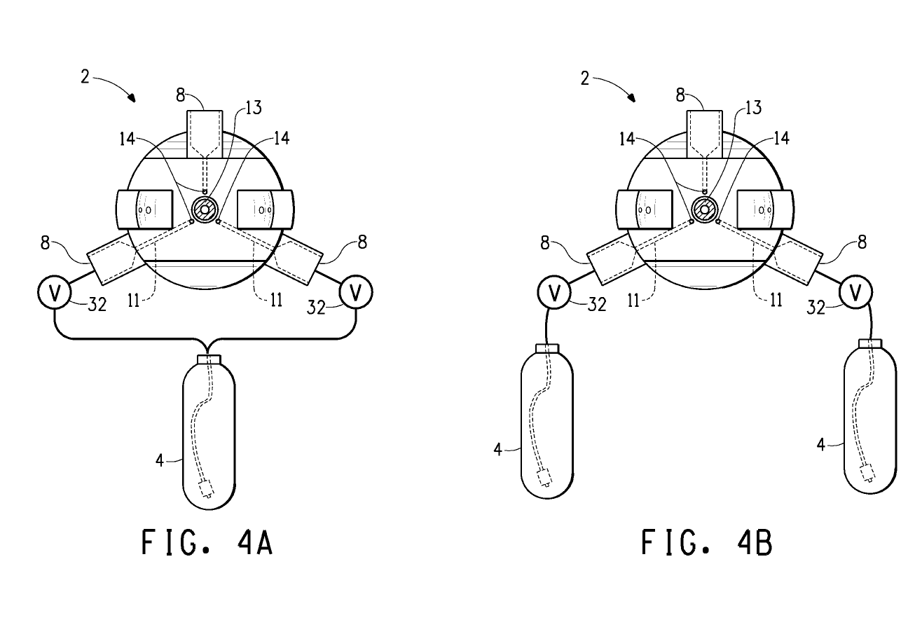

The second inlets can be connected to one or more container. In one example, two or three second inlets can be connected to a single container (4) that stores the second component (FIG. 4A). In another example, each of the second inlets is connected to an individual container that can contain the same or different component (FIG. 4B). For example, one of the containers can contain a catalyst while another container can contain initiators. If one or more second inlets are not used, they can be blocked or closed.

A flow control means (32), such as a valve, a commercial inline flow controller, or any other a controllable regulatory device, can be used to regulate flow of the second or a subsequent component from the respective container to the delivery outlet (FIGS. 4A and 4B). The flow control means can be coupled to any of the second inlet or be placed in a connection path connecting to that particular delivery outlet. The regulatory device can also be placed at any place along a tubing that delivers the second or the subsequent component from its storage container to the delivery outlet.

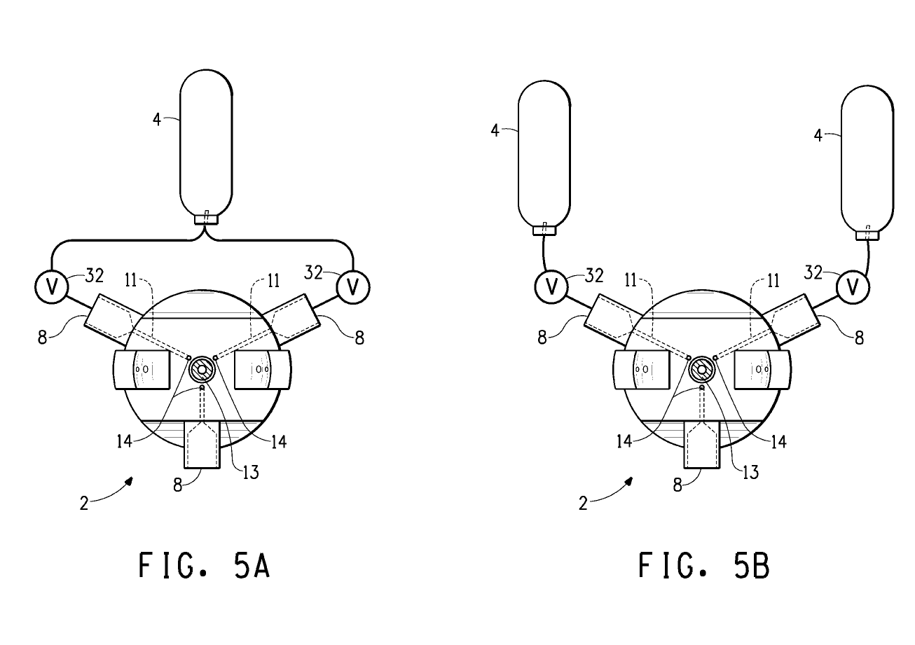

The container for the second component or any additional container for the subsequent component can be positioned below the delivery outlets, such as shown in FIGS. 4A and 4B, or above the delivery outlets, such as shown in FIGS. 5A and 5B. Typically, when the container is positioned below the delivery outlet, contents in the container, such as the second component, can be delivered by siphoning force from the siphon zone. When the container is positioned above the delivery outlet, content in the container, such as the second or the subsequent component can be fed into second inlet by gravity, or by both gravity and siphoning force. The flow control means can be used to control flow.

The container is typically not pressurized. The second component and the subsequent component can also be mixed and stored into a single container.

This invention is further directed to a method for producing a layer of a coating composition on a substrate using the spray gun. The coating composition can comprise two or more components. The method can comprise the following steps:
(A) providing a spray gun comprising: a spray gun body (1), a first inlet (10), a spray nozzle (13) having a nozzle axis longitudinal to said spray nozzle, an air cap (24), a second inlet (8), a second connection path (11), and a delivery outlet (14) having a delivery outlet axis substantially parallel to said nozzle axis;
wherein:
the first inlet is connected to said spray nozzle for conveying a first component of said coating composition to said spray nozzle;
the second inlet is connected to the delivery outlet through said delivery connection path for conveying a second component of said coating composition;
said spray nozzle is configured to produce a spray stream of atomized said first component creating a first siphon zone surrounding the spray nozzle; and
said delivery outlet is positioned within said siphon zone;
(B) producing said spray stream of atomized said first component from said spray nozzle and siphoning said second component from said delivery outlet into said spray stream to form a coating mixture; and
(C) applying the coating mixture on the substrate to form the layer of said coating composition thereon.

The method can further comprise the step of curing said layer of said coating composition at ambient temperatures, such as in a range of from 18° C. to 35° C., or at elevated temperatures, such as in a range of from 35° C. to 150° C. The layer can be cured for a time period in a range of from a few minutes, such as 5 to 10 minutes, to a few hours, such as 1 to 10 hours, or even to a few days, such as 1 to 2 days.

The spray stream can be produced by the spray gun using a pressurized carrier selected from compressed air, compressed gas, compressed gas mixture, or a combination thereof. Typically, a compressed air can be used.

The coating composition can be a 1K coating composition or a 2K coating composition. The coating composition can also be a mono-cure such as a chemical curable coating composition or a radiation curable coating composition; or a dual-cure coating composition, such as a chemical and radiation dual-cure coating composition.

In one example, the second component can be selected from a catalyst, an initiator, an activator, a radiation activator, a curing agent, or a combination thereof.

In one example, the coating composition is a UV coating composition wherein the first component comprises a UV curable component as described above and the second component comprises one or more photo initiators. In another example, the coating composition is a chemical curable coating composition wherein the first component comprises a crosslinkable component and a crosslinking component and the second component comprises a catalyst or a radiation activator such as a latent catalyst such as the photolatent catalyst. In yet another example, the first component comprises a crosslinkable component and the second component comprises a cosslinking component and a catalyst.

In yet another example, the coating composition is a dual-cure coating composition wherein the first component comprises a crosslinkable component, a crosslinking component and a UV curable component, and the second component comprises a catalyst and a photo initiator.

In yet another example, the first component comprises a crosslinkable component and the second component comprises a crosslinking component as a curing agent.

In yet another example, the first component comprises a radiation curable component and a crosslinkable component, and said second component comprises a crosslinking component.

In yet another example, the first component comprises a crosslinkable component, a crosslinking component and a radiation curable component, and said second component comprises a catalyst, a photo initiator, and optionally a radiation activator such as a photolatent catalyst.

In yet another example, the first component is a lacquer coating composition that comprises crosslinkable component. The second component can comprise a crosslinking component or a combination of a crosslinking component and a catalyst. Typically, a lacquer coating composition can dry to form a coating layer and does not require a crosslinking component. Adding an additional crosslinking component can typically reduce curing time and improve coating properties. Conventional method is to mix the lacquer with a crosslinking component in the way similar to the 2 k coating composition. However, such conventional method causes the coating mixture to have limited pot life similar to that of the 2 k coating composition. An advantage of this invention is to have the ability to cure a lacquer composition while maintaining extended pot life since the crosslinking component can be mixed with the lacquer after atomization of the lacquer. The rate of curing can easily be varied by changing the ratio of the lacquer composition to the crosslinking component.

In yet another example, the first component comprises protected crosslinkable groups and a crosslinking component. In one example, the protected crosslinkable groups are selected from the group consisting of amide acetal, orthocarbonate, orthoester, spiroorthoester, orthosilicate, oxazolidine and combinations thereof. In one example, the crosslinking component can comprise a compound, oligomer or polymer having crosslinking groups selected from the group consisting of isocyanate, amine, ketimine, melamine, epoxy, carboxylic acid, anhydride, and a combination thereof. Due to the presence of the protected crosslinkable functional groups, the crosslinkable and the crosslinking groups typically can not initiate crosslinking reaction. The protected crosslinkable groups can be activated by introducing water or water with acid. The water or the water with acid can be used as a second or a subsequent component using the spray gun.

In yet another example, the first component can comprise the aforementioned protected crosslinkable component and the second component can comprise the aforementioned crosslinking component. The water or water in combination with an acid can be used as a subsequent component.

In yet another example, the first component can comprise the aforementioned protected crosslinkable component and the second component can comprise a combination of the crosslinking component, the water or water in combination with an acid.

Another advantage of this invention can include the ability for controlling viscosity of a coating composition. The coating mixture can have a coating viscosity that is increasing upon time, while the first component and the second component can be at essentially constant individual viscosity. That means that the first component and the second component can be at an individual viscosity essentially constant at the beginning and the end of spray operation. This can be particularly useful for spraying coating compositions that viscosity increases very rapidly if all components are mixed together. By utilizing this invention, individual components of such coating compositions can be mixed after atomization. The viscosity of individual component can be essentially constant during spray operation. In one example, the first component comprises a crosslinkable component and a crosslinking component, and the second component comprises a catalyst. In another example, the first component comprises a crosslinkable component and the second component comprises a crosslinking component and a catalyst.

The substrate can be wood, plastic, leather, paper, woven and nonwoven fabrics, metal, plaster, cementitious and asphaltic substrates, and substrates that have one or more existing layers of coating thereon. The substrate can be vehicle body or vehicle parts thereof.

The storage container (4) containing the second or a subsequent component can be a flexible container, such as a plastic bag; a fixed-shape container, such as a canister made of metal or hard plastic; or a flexible inner container inside a fixed-shape container, such as a flexible plastic bag placed inside a fixed-shape metal container. A flexible container that can be collapsed easily is preferred. The flexible container can be a collapsible liner that can be sealed and used directly or be placed inside a fixed shape container. The storage container can be transparent or have a transparent window so the level of the content in the container can be readily visible. The storage container can have an indicator to indicate the level of the contents in the container. The storage container can be disposable or reusable.

The storage container can further have a unidirectional flow limiter to eliminate back flow, wherein said unidirectional flow limiter can only allow the content to flow in one direction, such as only from the container to the delivery outlet. Any back flow can be stopped by the directional flow limiter to avoid potential contamination. For a fixed-shape container, ventilation can be provided so the contents in the container can be maintained at atmosphere pressure.

Although coating compositions with multiple coating components are specifically described here, this invention can also be used for a composition having multiple components that need to be mixed to form a mixed composition. With this invention, a first component of the composition can be atomized by a spray device and a second or a subsequent component of the composition can be siphoned into the atomized first component to form the mixed composition.

### EXAMPLES

The present invention is further defined in the following Examples. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various uses and conditions.

### Coating Examples 1-3

DuPont ChromaClear® G2-7779S™, under respective registered or unregistered trademarks, is mixed with an activator 7775S (both available from E. I. duPont de Nemours and Company, Wilmington, USA) according to manufacturer's directions to form a first coating mix, also referred to as a first coating component. The first coating component is placed in the main storage container (also referred to as a first storage container) of a gravity spray gun. Various catalyst solutions are prepared according to Table 1. Each is used as a second coating component and is placed in a second container of the spray gun.

Mixing ratio of the first coating component/the second coating component is controlled at about 13/1 by selecting a suitable size of a connection tubing connecting the second container and the delivery outlet of the delivery device.

The clearcoats prepared above are sprayed over Uniprime (ED-5000, cold-rolled steel (04X12X032)B952 P60 DIW unpolish Ecoat POWERCRON 590 from ACT Laboratories, Hillsdale, Mich.) to a film thickness of 2.3 to 2.6 mils. The coatings are baked for 5 min or 10 min at 60° C. as indicated.

TABLE 1
Coating Compositions.

| | Example 1 | Example 2 | Example 3 |
|---|---|---|---|
| First | ChromaClear ® | ChromaClear ® | ChromaClear ® |
| Component | G2-7779S ™ | G2-7779S ™ | G2-7779S ™ |
| | mixed with | mixed with | mixed with |
| | activator 7775S | activator 7775S | activator 7775S |
| Second | 0.125% DBTDL | 0.125% DBTDL | 0.0625% DBTDL, |
| Component | in ethyl | and 2% acetic | and 0.5% acetic acid |
| | acetate | acid in ethyl | in ethyl acetate |
| | | acetate | |

DBTDL = dibutyltin dilaurate.

### Examples 4-6

DuPont ChromaClear® G2-7779S™ is placed in a first storage container of a gravity spray gun as a first coating component. The activator 7775S is placed in a second storage container of the spray gun as a second coating component. Mixing ratio between the first and the second coating component is set at about 12/3.

In Example 4, 0.125% of DBTDL as in Example 1 is used as a third coating component and placed in a third storage container. Mixing ratio of the first/the second/the third coating components is set as 12/3/1.

In Example 5, 0.125% of DBTDL and 2% acetic acid as in Example 2 is used as a third coating component and placed in a third storage container. Mixing ratio of the first/the second/the third coating components is set as 12/3/1.

In Example 6, 0.0625% of DBTDL and 0.5% acetic acid as in Example 3 is used as a third coating component and placed in a third storage container. Mixing ratio of the first/the second/the third coating components is set as 12/3/1.

Coatings are sprayed over substrates as described in Examples 1-3.

### Example 7

DuPont ChromaClear® G2-7779S™ is mixed with an activator 7775S as in Example 1-3 and is placed in the first storage container of a gravity spray gun as a first coating component.

DBTDL at the concentration of 0.25% is used as a second coating component and placed in a second storage container. Four percent acetic acid in ethyl acetate is used as a third coating component and placed in a third storage container.

A mixing ratio of the first/the second coating component=13/0.5 is used. During spray, a valve controlling the flow of the third coating component (4% acetic acid) is initially turned on so acetic acid is mixed into the coating mixture. The valve is then slowly turned off during spray so decreasing amount of acetic acid is mixed into the coating mixture. Coating is sprayed over substrates as described in Examples 1-3. Acetic acid is believed to modulate the activity of the catalyst DBTDL. With less acetic acid, the activity of DBTDL is higher so the coating can be cured faster. With decreasing amount of acetic acid during spray, the entire coating layer can cure evenly.

What is claimed is:

1. A method for producing a layer of a coating composition on a substrate, said method comprising the steps of:
(A) providing a spray gun comprising: a spray gun body (1), a first inlet (10), a spray nozzle (13) having a nozzle axis that is a rotational symmetry axis of said spray nozzle, an air cap (24), a second inlet (8), a second connection path (11), and a delivery outlet (14) having a delivery outlet axis substantially parallel to said nozzle axis;
wherein:
the first inlet is connected to said spray nozzle for conveying a first component of said coating composition to said spray nozzle;
the second inlet is connected to the delivery outlet through said delivery connection path for conveying a second component of said coating composition;
said spray nozzle is configured to produce a spray stream of atomized said first component creating a first siphon zone surrounding the spray nozzle; and
said delivery outlet is positioned within said siphon zone;
(B) producing said spray stream of atomized said first component from said spray nozzle and siphoning said second component from said delivery outlet into said spray stream to form a coating mixture; and
(C) applying the coating mixture on the substrate to form the layer of said coating composition thereon.

2. The method of claim 1 further comprising the step of curing said layer of said coating composition.

3. The method of claim 1, wherein the spray stream is produced by the spray gun using a pressurized carrier selected from compressed air, compressed gas, compressed gas mixture, or a combination thereof.

4. The method of claim 1, wherein said second component is selected from a catalyst, an initiator, an activator, a radiation activator, a curing agent, or a combination thereof.

5. The method of claim 1, wherein said substrate is a vehicle, vehicle body, or vehicle body parts.

6. The method of claim 1, wherein said delivery outlet is constructed in said air cap.

7. The method of claim 1, wherein the spray gun further comprises one or more subsequent second inlets and one or more subsequent delivery outlets, wherein each of the one or more subsequent inlets is connected to at least one of the one or more subsequent delivery outlets.

8. The method of claim 7 further comprising the step of conveying a subsequent component of the coating composition to the one or more subsequent second delivery outlets through the one or more subsequent second inlets.

9. The method of claim 1, wherein said coating composition is selected from a lacquer coating composition, a chemical curable coating composition, a radiation curable coating composition, or a chemical and radiation dual-cure coating composition.

10. The method of claim 1, wherein said first component comprises a crosslinkable and a crosslinking component and said second component comprises a catalyst or a latent catalyst.

11. The method of claim 1, wherein said first component comprises a radiation curable component and said second component comprises a photo initiator.

12. The method of claim 1, wherein said first component comprises a crosslinkable component, a crosslinking component and a radiation curable component, and said second component comprises a catalyst, an initiator, or a radiation activator.

13. The method of claim 1, wherein said first component comprises a crosslinkable component and said second component comprises a crosslinking component.

14. The method of claim 1, wherein said first component comprises a radiation curable component and a crosslinkable component, and said second component comprises a crosslinking component.

15. The method of claim 1, wherein said first component comprises protected crosslinkable groups and a crosslinking component, and wherein said second or said subsequent component comprises water and optionally an acid.

16. The method of claim 1, wherein said first component comprises protected crosslinkable groups, and said second or said subsequent component comprises a crosslinking component, water, and optionally an acid.

17. The method of claim 1, wherein said coating mixture has a coating viscosity that is increasing upon time and said first component and said second component are at essentially constant individual viscosity upon time.

18. The method of claim 1, wherein said substrate is vehicle body or parts thereof.

19. The method of claim 1, wherein said spray gun further comprises a second air channel for producing a second siphon zone.

20. The method of claim 1, wherein said second air channel (38) is configured within said delivery outlet (14).

21. A method for controlling viscosity of a coating composition comprising a first component and a second component, wherein said first component reacts with said second component causing increasing viscosity of said coating composition, said method comprising the steps of:
i) providing a spray gun comprising: a spray gun body (1), a first inlet (10), a spray nozzle (13) having a nozzle axis that is a rotational symmetry axis of said spray nozzle, an air cap (24), a second inlet (8), a second connection path (11), and a delivery outlet (14) having a delivery outlet axis substantially parallel to said nozzle axis;
wherein:
the first inlet is connected to said spray nozzle for conveying a first component of said coating composition to said spray nozzle;
the second inlet is connected to the delivery outlet through said delivery connection path for conveying a second component of said coating composition;
said spray nozzle is configured to produce a spray stream of atomized said first component creating a first siphon zone surrounding the spray nozzle; and
said delivery outlet is positioned within said siphon zone;
ii) producing said spray stream of atomized said first component from said spray nozzle and siphoning said second component from said delivery outlet into said spray stream to form a coating mixture;
wherein said coating mixture has a coating viscosity that is increasing upon time and said first component and said second component are at essentially constant individual viscosity upon time.
